(19) United States
(12) Patent Application Publication
(10) Pub. No.: US 2025/0071330 A1
(43) Pub. Date: Feb. 27, 2025

(54) VIDEO DECODING APPARATUS, POST-IMAGE PROCESSING APPARATUS, VIDEO CODING APPARATUS, VIDEO DECODING METHOD, AND VIDEO CODING METHOD

(71) Applicant: SHARP KABUSHIKI KAISHA, Sakai City, Osaka (JP)

(72) Inventors: TAKESHI CHUJOH, Sakai City, Osaka (JP); TOMOHIRO IKAI, Sakai City, Osaka (JP); Takuya SUZUKI, Sakai City, Osaka (JP); YUKINOBU YASUGI, Sakai City, Osaka (JP); HIROSHI WATANABE, Tokyo (JP)

(21) Appl. No.: 18/719,272

(22) PCT Filed: Dec. 7, 2022
(86) PCT No.: PCT/JP2022/045001

§ 371 Date: Jun. 13, 2024

(30) Foreign Application Priority Data
Dec. 14, 2021 (JP) 2021-202161

(51) Int. Cl. H04N 19/70; H04N 19/44

(52) U.S. Cl. CPC H04N 19/70; H04N 19/44

(57) ABSTRACT

A video decoding apparatus is an image decoding apparatus for decoding an image from coded data, and includes at least a supplemental information decoder for decoding supplemental information indicating at least one of a position, a size, or a type of a recognition target of a decoded image.

### TECHNICAL FIELD

An embodiment of the present invention relates to a video decoding apparatus, a post-image processing apparatus, a video coding apparatus, a video decoding method, a video coding method, and the like. This application claims priority based on JP 2021-202161 filed in Japan on Dec. 14, 2021, the contents of which are incorporated herein by reference.

### BACKGROUND ART

A video coding apparatus which generates coded data by coding a video, and a video decoding apparatus which generates decoded images by decoding coded data are used for efficient transmission or recording of videos.

Specific video coding schemes include, for example, H.264/AVC and an H.265/High-Efficiency Video Coding (HEVC) scheme, and the like.

In such a video coding scheme, images (pictures) constituting a video are managed in a hierarchical structure including slices obtained by splitting an image, Coding Tree Units (CTUs) obtained by splitting a slice, Coding Units (CUs) obtained by splitting a coding tree unit, and Transform Units (TUs) obtained by splitting a coding unit, and are coded/decoded for each CU.

In such a video coding scheme, usually, a prediction image is generated based on a locally decoded image that is obtained by coding/decoding an input image, and a prediction error (which may be referred to also as a “difference image” or a “residual image”) obtained by subtracting the prediction image from the input image (source image) is coded. Generation methods of prediction images include inter-picture prediction (inter prediction) and intra-picture prediction (intra prediction).

In addition, NPL 1 introduces an example of the recent technology for video coding and decoding. NPL 1 discloses a video coding and decoding scheme with very high coding efficiency. NPL 2 discusses a method of integrating description about analysis results of videos and video coding.

### CITATION LIST

### Non Patent Literature

NPL 1: ITU-T Recommendation H. 266
NPL 2: L.-Y. Duan, J. Liu, W. Yang, T. Huang and W. Gao, “Video Coding for Machines: A Paradigm of Collaborative Compression and Intelligent Analytics”, IEEE Trans. Image Processing, vol. 29, pp. 8680 to 8695

### SUMMARY OF INVENTION

### Technical Problem

However, although NPL 1 is about a video coding and decoding scheme having high coding efficiency, there is a problem that, when image recognition is performed on a decoded video, the accuracy in image recognition becomes lower due to coding distortion in a case that a transmission rate is low.

In addition, although NPL 2 discloses a method of integrating description about analysis results of a video and video coding, the method is not sufficient in terms of coding efficiency and has a problem that a low transmission bit rate cannot be realized.

### Solution to Problem

A video decoding apparatus according to an aspect of the present invention is an image decoding apparatus for decoding an image from coded data, and includes at least a supplemental information decoder for decoding supplemental information indicating at least one of a position, a size, or a type of a recognition target of a decoded image.

A post-image processing apparatus according to an aspect of the present invention uses a network parameter decoded by a supplemental information decoder for decoding supplemental information indicating at least one of a position, a size, or a type of a recognition target of an image to perform post-image processing.

A video coding apparatus according to an aspect of the present invention is an image coding apparatus for coding an input image, and includes at least a supplemental information coder for coding supplemental information indicating at least one of a position, a size, or a type of a recognition target of the input image.

A video decoding method according to an aspect of the present invention is an image decoding method for decoding an image from coded data, and includes at least a step of decoding supplemental information indicating at least one of a position, a size, or a type of a recognition target of a decoded image.

A video coding method according to an aspect of the present invention is an image coding method for coding an input image, the method including at least a step of coding supplemental information indicating at least one of a position, a size, or a type of a recognition target of the input image.

### Advantageous Effects of Invention

With such a configuration, the problem of maintaining the accuracy in image recognition even at a low rate can be solved by coding and decoding additional supplemental information without greatly changing the framework of a video coding and decoding scheme.

### BRIEF DESCRIPTION OF DRAWINGS

FIG. 1 is a schematic diagram illustrating a configuration of a video transmission system according to the present embodiment.

FIG. 2 is a diagram illustrating a hierarchical structure of coded data.

FIG. 3 is a conceptual diagram of an image to be processed in the video transmission system according to the present embodiment.

FIG. 4 is a conceptual diagram illustrating examples of reference pictures and reference picture lists.

FIG. 5 is a schematic diagram illustrating a configuration of an image decoding apparatus.

FIG. 6 is a flowchart illustrating a general operation of the image decoding apparatus.

FIG. 7 is a block diagram illustrating a configuration of the image coding apparatus.

FIG. 8 is a diagram illustrating a configuration example of a syntax table of SEI of image recognition supplemental information defining supplemental information of an embodiment.

FIG. 9 is a schematic diagram illustrating a configuration of another video transmission system according to the present embodiment.

FIG. 10 is a diagram illustrating a configuration example of a syntax table of SEI of a network parameter defining supplemental information of an embodiment.

FIG. 11 is a diagram illustrating a configuration example of a syntax table of APS defining image recognition supplemental information according to an embodiment.

FIG. 12 is a diagram illustrating a configuration example of a syntax table of APS defining image recognition supplemental information according to an embodiment.

### DESCRIPTION OF EMBODIMENTS

### First Embodiment

Embodiments of the present invention will be described below with reference to the drawings.

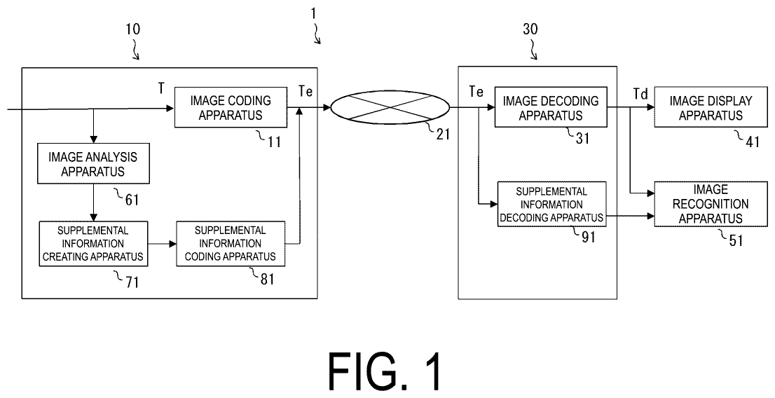

FIG. 1 is a schematic diagram illustrating a configuration of a video transmission system according to the present embodiment.

The video transmission system 1 is a system in which coded data obtained by coding an image is transmitted, the transmitted coded data is decoded and displayed, and recognition of the image is performed. The video transmission system 1 includes a video coding apparatus 10, a network 21, a video decoding apparatus 30, an image display apparatus 41, and an image recognition apparatus 51.

The video coding apparatus 10 includes an image coding apparatus (image coder) 11, an image analysis apparatus (image analyzer) 61, a supplemental information creating apparatus (supplemental information generator) 71, and a supplemental information coding apparatus (supplemental information coder) 81.

The video decoding apparatus 30 includes an image decoding apparatus (image decoder) 31 and a supplemental information decoding apparatus (supplemental information decoder) 91.

The image coding apparatus 11 compresses and codes an input video T.

The image analysis apparatus 61 analyzes the input video T, analyzes information indicating which region in a picture should be used in the image recognition apparatus 51, and transmits the analysis result to the supplemental information creating apparatus 71.

Based on the analysis result of the image analysis apparatus 61, the supplemental information creating apparatus 71 generates, for the picture, information indicating whether to cause the image recognition apparatus to operate and supplemental information indicating for which region in the picture the image recognition apparatus should be caused to operate, and transmits the supplemental information to the supplemental information coding apparatus 81.

The supplemental information coding apparatus 81 codes the supplemental information created by the supplemental information creating apparatus 71 in accordance with predetermined syntax. The output of the image coding apparatus 11 and the output of the supplemental information coding apparatus 81 are sent to the network 21 as coded data Te.

The video coding apparatus 10 receives an input image T as an input, compresses and codes the image, analyzes the image, generates supplemental information to be input to the image recognition apparatus 51, codes the supplemental information, generates coded data Te, and transmits the coded data Te to the network 21.

Although the supplemental information coding apparatus 81 is not connected to the image coding apparatus 11 in FIG. 1, the supplemental information coding apparatus 81 and the image coding apparatus 11 may communicate necessary information as appropriate.

The network 21 transmits the coded supplemental information and the coded data Te to the image decoding apparatus 31. A part or all of the coded supplemental information may be included in the coded data Te as supplemental information SEI. The network 21 is the Internet, a Wide Area Network (WAN), a Local Area Network (LAN), or a combination thereof. The network 21 is not necessarily a bidirectional communication network and may be a unidirectional communication network that transmits broadcast waves for terrestrial digital broadcasting, satellite broadcasting, or the like. In addition, the network 21 may be substituted by a storage medium in which the coded data Te is recorded, such as a Digital Versatile Disc (DVD) (trade name) or a Blu-ray Disc (BD) (trade name).

The video decoding apparatus 30 receives the coded data Te transmitted from the network 21 as an input, decodes the video Td, and transmits the decoded image to the image display apparatus 41 and the image recognition apparatus 51. In addition, the supplemental information is decoded and output to the image recognition apparatus 51.

The image decoding apparatus 31 decodes each piece of the coded data Te transmitted from the network 21 to generate the decoded video Td, and supplies the decoded video to the image display apparatus 41 and the image recognition apparatus 51.

The supplemental information decoding apparatus 91 decodes the coded supplemental information transmitted from the network 21 to generate supplemental information and transmits the supplemental information to the image recognition apparatus 51.

Although the supplemental information decoding apparatus 91 is illustrated separately from the image decoding apparatus 31 in FIG. 1, the supplemental information decoding apparatus 91 may be included in the image decoding apparatus 31. For example, the supplemental information decoding apparatus 91 may be included in the image decoding apparatus 31 separately from each functional unit of the image decoding apparatus 31. In addition, although the supplemental information decoding apparatus 91 is not connected to the image decoding apparatus 31 in FIG. 1, the supplemental information decoding apparatus 91 and the image decoding apparatus 31 may communicate necessary information as appropriate.

The image display apparatus 41 displays all or part of the decoded video Td input from the image decoding apparatus 31. For example, the image display apparatus 41 includes a display device such as a liquid crystal display and an organic Electro-luminescence (EL) display. Examples of display types include stationary, mobile, and HMD. In a case that the image decoding apparatus 31 has a high processing capability, an image having high image quality is displayed, and in a case that the apparatus has a lower processing capability, an image which does not require high processing capability and display capability is displayed.

The image recognition apparatus 51 uses the decoded video Td decoded by the image decoding apparatus 31 and the supplemental information decoded by the supplemental information decoding apparatus 91 to perform object detection of an image, segmentation of regions of an object, tracking of an object, motion recognition, human motion evaluation, and the like.

With such a configuration, it is possible to provide a framework capable of maintaining the accuracy in image recognition even at a low rate by coding and decoding additional supplemental information without greatly changing the framework of a video coding and decoding scheme.

### Operators

Operators used in the present specification will be described below.
“>>” is a right bit shift, “<<” is a left bit shift, “&” is a bitwise AND, “|” is a bitwise OR, “|=” is an OR assignment operator, and “∥” indicates a logical sum.
x?“y:z” is a ternary operator that takes y in a case that x is true (not 0) and takes z in a case that x is false (0).

Clip3(a, b, c) is a function to clip c in a value from a to b, and a function to return a in a case that c is smaller than a (c<a), return b in a case that c is greater than b (c>b), and return c in the other cases (provided that a is smaller than or equal to b (a<=b)).
abs(a) is a function that returns the absolute value of a.
Int(a) is a function that returns the integer value of a.
floor(a) is a function that returns the maximum integer equal to or smaller than a.
ceil(a) is a function that returns the minimum integer equal to or greater than a.
a/d represents division of a by d (round down decimal places).

### Structure of Coded Data Te

Prior to the detailed description of the image coding apparatus 11 and the image decoding apparatus 31 according to the present embodiment, a data structure of the coded data Te generated by the image coding apparatus 11 and decoded by the image decoding apparatus 31 will be described.

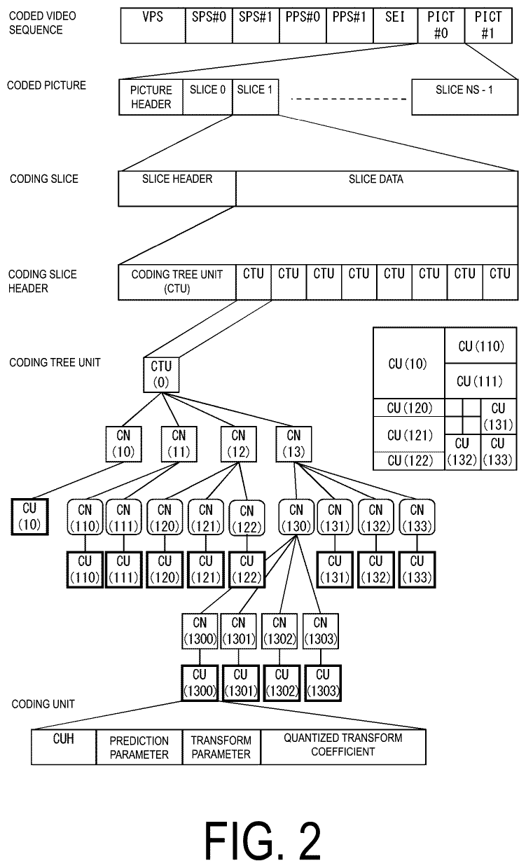

FIG. 2 is a diagram illustrating a hierarchical structure of data of the coded data Te. The coded data Te includes a sequence and multiple pictures constituting the sequence illustratively. FIG. 2 is a diagram illustrating a coded video sequence predetermining a sequence SEQ, a coded picture defining a picture PICT, a coding slice defining a slice S, coding slice data defining slice data, a coding tree unit included in the coding slice data, and a coding unit included in the coding tree unit.

### Coded Video Sequence

In the coded video sequence, a set of data referred to by the image decoding apparatus 31 to decode the sequence SEQ to be processed is defined. As illustrated in FIG. 2, the sequence SEQ includes a Video Parameter Set VPS, a Sequence Parameter Set SPS, a Picture Parameter Set PPS, an Adaptation Parameter Set (APS), a picture PICT, and Supplemental Enhancement Information SEI.

In the video parameter set VPS, with respect to a video including multiple layers, a set of coding parameters common to multiple videos and a set of coding parameters associated with the multiple layers and an individual layer included in the video are defined.

In the sequence parameter set SPS, a set of coding parameters referred to by the image decoding apparatus 31 to decode a target sequence is defined. For example, a width and a height of a picture are defined. Further, multiple SPSs may exist. In that case, any of the multiple SPSs is selected from the PPS.

Here, the sequence parameter set SPS includes the following syntax elements.

pic_width_max_in_luma_samples is a syntax element indicating, in units of luminance blocks, the width of one of images in a single sequence, the image having the largest width. In addition, the syntax element has a value required to not be 0 and to be an integer multiple of Max(8, MinCbSizeY). Here, MinCbSizeY is a value determined by the minimum size of the luminance blocks.

pic_height_max_in_luma_samples is a syntax element indicating, in units of luminance blocks, the height of one of the images in a single sequence, the image having the largest height. In addition, the syntax element has a value required to not be 0 and to be an integer multiple of Max(8, MinCbSizeY).

In the picture parameter set PPS, a set of coding parameters referred to by the image decoding apparatus 31 to decode each picture in a target sequence is defined. Further, multiple PPSs may exist. In that case, any of the multiple PPSs is selected from each picture in a target sequence.

Here, the picture parameter set PPS includes the following syntax elements.

pic_width_in_luma_samples is a syntax element indicating the width of a target picture. The value of the syntax element is required to not be 0 and to be an integer multiple of Max(8, MinCbSizeY) and equal to or less than pic_width_max_in_luma_samples.

pic_height_in_luma_samples is a syntax element indicating the height of the target picture. The value of the syntax element is required to not be 0 and to be an integer multiple of Max(8, MinCbSizeY) and equal to or less than pic_height_max_in_luma_samples.

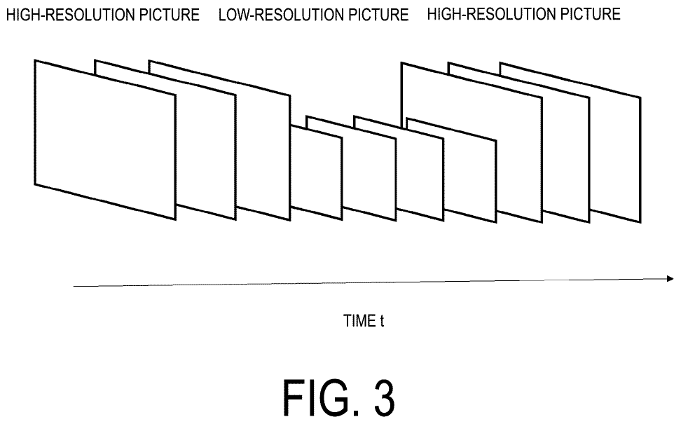

FIG. 3 is a conceptual diagram of an image to be processed in the video transmission system 1 and is a diagram illustrating a change in resolution of the image over time. However, in FIG. 3, whether the image is coded is not distinguished. FIG. 3 illustrates an example in which, in the course of processing in the video transmission system 1, an image is transmitted to the image decoding apparatus 31 with the resolution adaptively changed by using a picture parameter set PPS.

### Coded Picture

In a coded picture, a set of data referred to by the image decoding apparatus 31 to decode a picture PICT to be processed is defined. As illustrated in FIG. 2, the picture PICT includes a picture header PH and slices 0 to NS-1 (NS is the total number of slices included in the picture PICT).

In the description below, in a case that the slices 0 to NS-1 need not be distinguished from one another, suffixes of reference signs may be omitted. In addition, the same applies to other data with suffixes included in the coded data Te which will be described below.

### Coding Slice

In a coding slice, a set of data referred to by the image decoding apparatus 31 to decode a slice S to be processed is defined. The slice includes a slice header and slice data as illustrated in FIG. 2.

The slice header includes a coding parameter group referenced by the image decoding apparatus 31 to determine a decoding method for a target slice. Slice type indication information (slice_type) indicating a slice type is one example of a coding parameter included in the slice header.

Examples of slice types that can be indicated by the slice type indication information include (1) I slice for which only intra prediction is used in coding, (2) P slice for which uni-prediction (L0 prediction) or intra prediction is used in coding, and (3) B slice for which uni-prediction (L0 prediction or L1 prediction), bi-prediction, or intra prediction is used in coding, and the like. Further, the inter prediction is not limited to uni-prediction and bi-prediction, and a prediction image may be generated by using a larger number of reference pictures. Hereinafter, in a case of a slice being referred to as a P or B slice, it indicates a slice including a block in which inter prediction can be used.

Further, the slice header may include a reference to the picture parameter set PPS (pic_parameter_set_id).

### Coding Slice Data

In coding slice data, a set of data referred to by the image decoding apparatus 31 to decode slice data to be processed is defined. Slice data includes CTUs as illustrated in the coding slice header of FIG. 2. A CTU is a block in a fixed size (for example, 64×64) constituting a slice, and may also be called a Largest Coding Unit (LCU).

### Coding Tree Unit

In FIG. 2, the set of data referred to by the image decoding apparatus 31 to decode a CTU to be processed is defined. The CTU is split into coding units CUs, each of which is a basic unit of coding processing, by a recursive Quad Tree (QT) split, Binary Tree (BT) split, or Ternary Tree (TT) split. The BT split and the TT split are collectively referred to as Multi Tree (MT) split. A node of a tree structure obtained by recursive quad tree split is referred to as a Coding Node. An intermediate node of a quad tree, a binary tree, and a ternary tree is a coding node, and a CTU itself is also defined as the highest coding node.

### Coding Unit

In FIG. 2, a set of data referred to by the image decoding apparatus 31 to decode a coding unit to be processed is defined. Specifically, a CU includes a CU header CUH, a prediction parameter, a transform parameter, a quantized transform coefficient, and the like. In the CU header, a prediction mode and the like are defined.

The prediction processing may be performed on a CU basis or performed on a sub-CU basis, the sub-CU being obtained by further splitting the CU. In a case that a CU and a sub-CU have an equal size, the number of sub-CUs in the CU is one. In a case that a CU has a size larger than that of a sub-CU, the CU is split into sub-CUs. For example, in a case that a CU has a size of 8×8, and a sub-CU has a size of 4×4, the CU is split into four sub-CUs which include two horizontal splits and two vertical splits.

There are two types of prediction (prediction modes), which are intra prediction and inter prediction. Intra prediction refers to prediction in the same picture, and inter prediction refers to prediction processing performed between different pictures (for example, between pictures of different display times, and between pictures of different layer images).

Although transform and quantization processing is performed on a CU basis, entropy coding of a quantized transform coefficient may be performed on a per subblock basis such as 4×4.

### Prediction Parameters

A prediction image is derived by prediction parameters associated with blocks. The prediction parameters include intra-prediction and inter-prediction parameters.

The prediction parameters for inter prediction will be described below. Inter-prediction parameters include prediction list utilization flags predFlagL0 and predFlagL1, reference picture indices refIdxL0 and refIdxL1, and motion vectors mvL0 and mvL1. predFlagL0 and predFlagL1 are flags indicating whether reference picture lists (L0 list and L1 list) are used, and in a case that the value of each of the flags is 1, a corresponding reference picture list is used. Further, in a case that the present specification mentions “a flag indicating whether XX is applied”, the flag indicating a value other than 0 (for example, 1) means a case where XX is applied, and the flag indicating 0 means a case where XX is not applied, and 1 is treated as true and 0 is treated as false in a logical negation, a logical product, and the like (hereinafter, the same applies). However, other values can be used for true values and false values in real apparatuses and methods.

### Reference Picture List

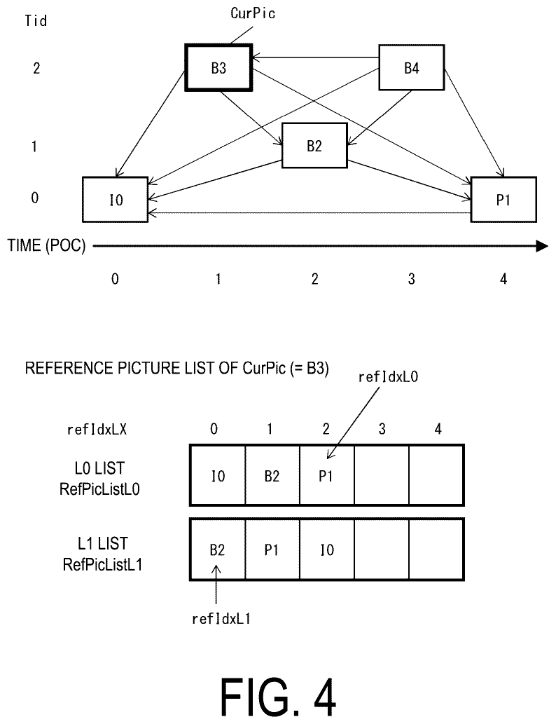

A reference picture list is a list including reference pictures stored in a reference picture memory 306. FIG. 4 is a conceptual diagram illustrating an example of reference pictures and reference picture lists. In the conceptual diagram illustrating an example of reference pictures in FIG. 4, rectangles indicate pictures, arrows indicate reference relationships among the pictures, the horizontal axis indicates time, I, P, and B in the rectangles respectively indicate an intra-picture, a uni-prediction picture, and a bi-prediction picture, and numbers in the rectangles indicate decoding order. As illustrated, the order of decoding the pictures is I0, P1, B2, B3, and B4, and the order of displaying thereof is I0, B3, B2, B4, and P1. FIG. 4 illustrates an example of reference picture lists of the picture B3 (target picture). The reference picture lists are lists representing candidates for a reference picture, and one picture (slice) may include one or more reference picture lists. In the illustrated example, the target picture B3 includes two reference picture lists, i.e., an L0 list RefPicList0 and an L1 list RefPicList1. For individual CUs, which picture in a reference picture list RefPicListX (X=0 or 1) is actually referred to is indicated with refIdxLX. The diagram illustrates an example of refIdxL0=2, refIdxL1=0. Further, LX is a description method used in a case of not distinguishing L0 prediction and L1 prediction, and in the following description, distinguishes parameters for the L0 list and parameters for the L1 list by replacing LX with L0 and L1.

### Configuration of Image Decoding Apparatus

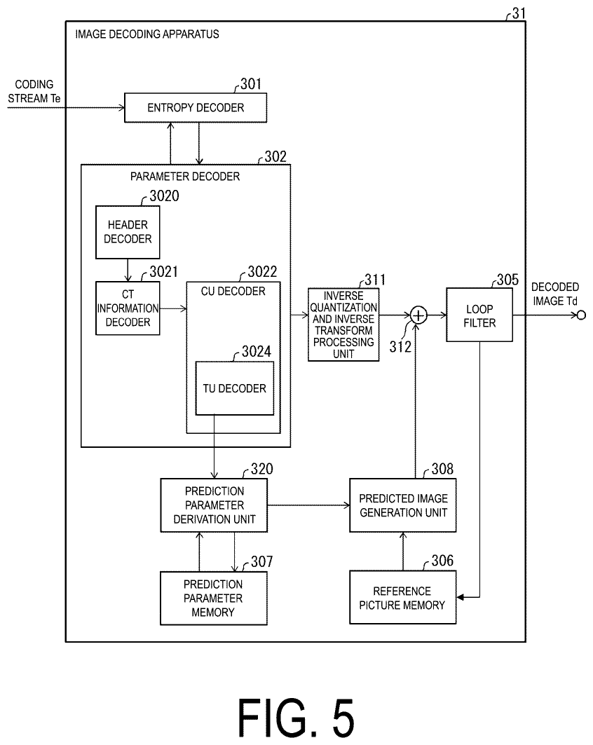

A configuration of the image decoding apparatus 31 (FIG. 5) according to the present embodiment will be described.

The image decoding apparatus 31 is configured to include an entropy decoder 301, a parameter decoder (a prediction image decoding apparatus) 302, a loop filter 305, a reference picture memory 306, a prediction parameter memory 307, a prediction image generator (prediction image generation apparatus) 308, an inverse quantization and inverse transform processing unit 311, an addition unit 312, and a prediction parameter derivation unit 320. Further, the image decoding apparatus 31 may be configured to not include the loop filter 305 in accordance with the image coding apparatus 11 described later.

The parameter decoder 302 further includes a header decoder 3020, a CT information decoder 3021, and a CU decoder 3022 (prediction mode decoder), and the CU decoder 3022 further includes a TU decoder 3024. These may be collectively referred to as a decoding module. The header decoder 3020 decodes, from coded data, parameter set information such as a VPS, an SPS, a PPS, and an APS, and a slice header (slice information). The CT information decoder 3021 decodes a CT from coded data. The CU decoder 3022 decodes a CU from coded data. In a case that a TU includes a prediction error, the TU decoder 3024 decodes QP update information (quantization correction value) and a quantization prediction error (residual_coding) from coded data.

In addition, although an example in which CTU and CU are used as a unit of processing will be described below, the unit of processing is not limited to this example, and processing may be performed on a sub-CU basis. Alternatively, the CTU or the CU may be referred to as a block, the sub-CU may be referred to as a subblock, and processing may be performed on a per-block or per-subblock basis.

The entropy decoder 301 performs entropy decoding on the coded data Te input from an external source and decodes individual codes (syntax elements). The entropy coding includes a method in which variable-length coding of syntax elements is performed by using a context (probability model) adaptively selected according to a type of syntax element and a surrounding condition, and a method in which variable-length coding of syntax elements is performed by using a predetermined table or formula. The former Context Adaptive Binary Arithmetic Coding (CABAC) stores in memory a CABAC state of the context (the type of a dominant symbol (0 or 1) and a probability state index pStateldx indicating a probability). The entropy decoder 301 initializes all CABAC states at the beginning of a segment (tile, CTU row, or slice). The entropy decoder 301 transforms the syntax element into a binary string (Bin String) and decodes each bit of the Bin String. In a case that the context is used, a context index ctxInc is derived for each bit of the syntax element, the bit is decoded using the context, and the CABAC state of the context used is updated. Bits that do not use the context are decoded at an equal probability (EP, bypass), and the ctxInc derivation and CABAC state are omitted. The decoded syntax element includes prediction information for generating a prediction image, a prediction error for generating a difference image, and the like.

The entropy decoder 301 outputs the decoded codes to the parameter decoder 302. Which code is to be decoded is controlled based on an indication of the parameter decoder 302.

### Basic Flow

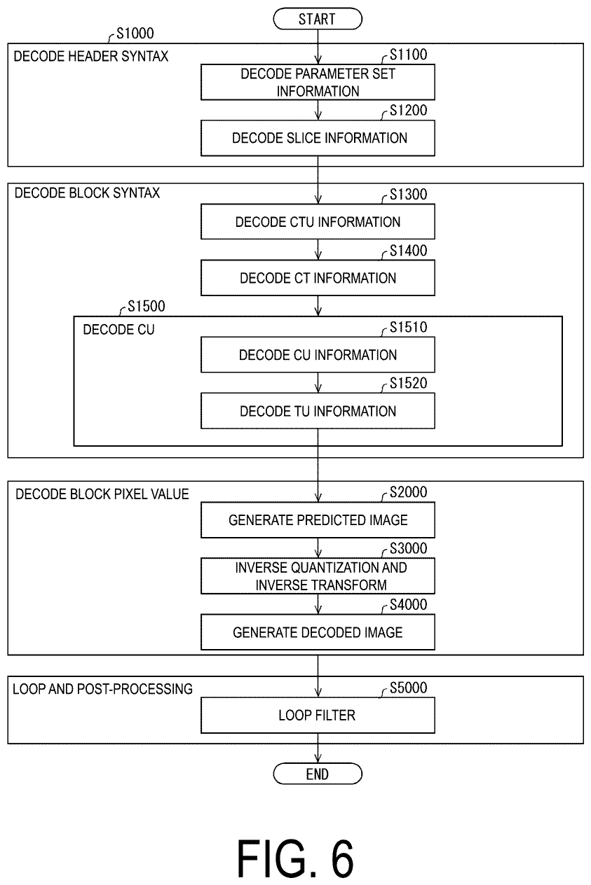

FIG. 6 is a flowchart illustrating a general operation of the image decoding apparatus 31.

(S1100: Decoding of parameter set information) The header decoder 3020 decodes parameter set information such as a VPS, an SPS, and a PPS from coded data.

(S1200: Decoding of slice information) The header decoder 3020 decodes a slice header (slice information) from the coded data.

Afterwards, the image decoding apparatus 31 repeats the processing from S1300 to S5000 for each CTU included in the target picture, and thereby derives a decoded image of each CTU.

(S1300: Decoding of CTU information) The CT information decoder 3021 decodes the CTU from the coded data.

(S1400: Decoding of CT information) The CT information decoder 3021 decodes the CT from the coded data.

(S1500: Decoding of CU) The CU decoder 3022 decodes the CU from the coded data by performing S1510 and S1520.

(S1510: Decoding of CU information) The CU decoder 3022 decodes CU information, prediction information, a TU split flag split_transform_flag, a CU residual flag cbf_cb, cbf_cr, and cbf_luma from the coded data.

(S1520: Decoding of TU information) In a case that the TU includes a prediction error, the TU decoder 3024 decodes, from the coded data, QP update information and a quantization prediction error. Further, QP update information is a difference value from a quantization parameter prediction value qPpred, which is a prediction value of a quantization parameter QP.

(S2000: Generation of prediction image) The prediction image generator 308 generates a prediction image, based on the prediction information, for each block included in the target CU.

(S3000: Inverse quantization and inverse transform) The inverse quantization and inverse transform processing unit 311 performs inverse quantization and inverse transform processing on each TU included in the target CU.

(S4000: Generation of decoded image) The addition unit 312 generates a decoded image of the target CU by adding the prediction image supplied by the prediction image generator 308 and the prediction error supplied by the inverse quantization and inverse transform processing unit 311.

(S5000: Loop filter) The loop filter 305 generates a decoded image by applying a loop filter such as a deblocking filter, an SAO, and an ALF to the decoded image.

The prediction parameter derivation unit 320 derives an inter-prediction parameter with reference to the prediction parameters stored in the prediction parameter memory 307 based on the syntax element input from the parameter decoder 302. In addition, the prediction parameters are output to the prediction image generator 308 and the prediction parameter memory 307.

The loop filter 305 is a filter provided in the coding loop, and is a filter that removes block distortion and ringing distortion and improves image quality. The loop filter 305 applies a filter such as a deblocking filter, a sample adaptive offset (SAO), and an adaptive loop filter (ALF) to a decoded image of a CU generated by the addition unit 312.

The reference picture memory 306 stores the decoded image of the CU in a predefined position for each target picture and target CU.

The prediction parameter memory 307 stores the prediction parameter in a predefined position for each CTU or CU. Specifically, the prediction parameter memory 307 stores the parameter decoded by the parameter decoder 302, the parameter derived by the prediction parameter derivation unit 320, and the like.

Parameters derived by the prediction parameter derivation unit 320 are input to the prediction image generator 308. In addition, the prediction image generator 308 reads out a reference picture from the reference picture memory 306. The prediction image generator 308 generates a prediction image of a block or a subblock by using the parameters and the reference picture (reference picture block) in the prediction mode indicated by predMode. Here, the reference picture block refers to a set of pixels (referred to as a block because they are normally rectangular) on a reference picture and is a region that is referred to for generating a prediction image.

The inverse quantization and inverse transform processing unit 311 performs inverse quantization on a quantized transform coefficient input from the parameter decoder 302 to calculate a transform coefficient.

The addition unit 312 adds the prediction image of the block input from the prediction image generator 308 and the prediction error input from the inverse quantization and inverse transform processing unit 311 for each pixel, and generates a decoded image of the block. The addition unit 312 stores the decoded image of the block in the reference picture memory 306, and also outputs it to the loop filter 305.

The inverse quantization and inverse transform processing unit 311 performs inverse quantization on a quantized transform coefficient input from the parameter decoder 302 to calculate a transform coefficient.

The addition unit 312 adds the prediction image of the block input from the prediction image generator 308 and the prediction error input from the inverse quantization and inverse transform processing unit 311 for each pixel, and generates a decoded image of the block. The addition unit 312 stores the decoded image of the block in the reference picture memory 306, and also outputs it to the loop filter 305.

### Configuration of Image Coding Apparatus

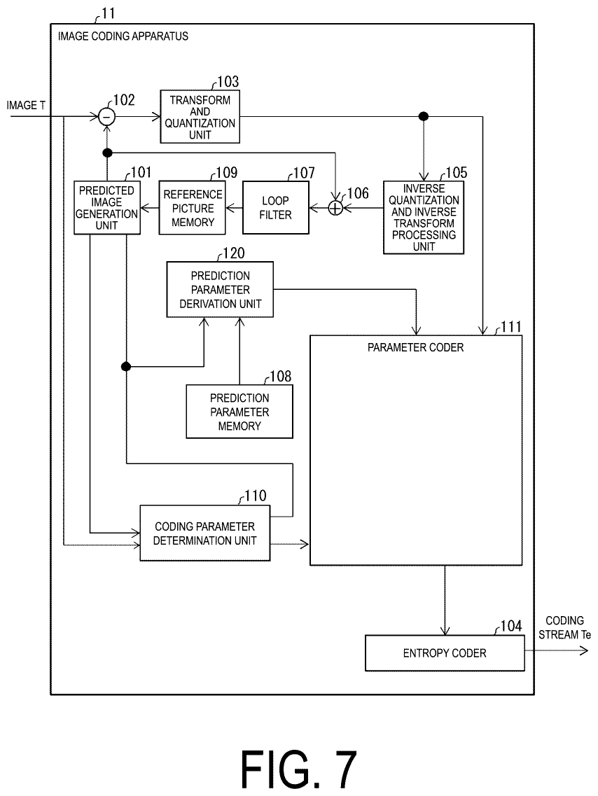

Next, a configuration of the image coding apparatus 11 according to the present embodiment will be described. FIG. 7 is a block diagram illustrating a configuration of the image coding apparatus 11 according to the present embodiment. The image coding apparatus 11 is configured to include a prediction image generator 101, a subtraction unit 102, a transform and quantization unit 103, an inverse quantization and inverse transform processing unit 105, an addition unit 106, a loop filter 107, a prediction parameter memory (a prediction parameter storage unit or a frame memory) 108, a reference picture memory (a reference image storage unit or a frame memory) 109, a coding parameter determination unit 110, a parameter coder 111, a prediction parameter derivation unit 120, and an entropy coder 104.

The prediction image generator 101 generates a prediction image for each CU.

The subtraction unit 102 subtracts a pixel value of the prediction image of a block input from the prediction image generator 101 from a pixel value of an image T to generate a prediction error. The subtraction unit 102 outputs the prediction error to the transform and quantization unit 103.

The transform and quantization unit 103 performs a frequency transform on the prediction error input from the subtraction unit 102 to calculate a transform coefficient, and derives a quantized transform coefficient by quantization. The transform and quantization unit 103 outputs the quantized transform coefficient to the parameter coder 111 and the inverse quantization and inverse transform processing unit 105.

The inverse quantization and inverse transform processing unit 105 is the same as the inverse quantization and inverse transform processing unit 311 (FIG. 5) of the image decoding apparatus 31, and description thereof is omitted. The calculated prediction error is output to the addition unit 106.

The parameter coder 111 performs coding processing of parameters such as header information, split information, prediction information, quantized transform coefficients, and the like.

The parameter coder 111 inputs the quantized transform coefficients and the coding parameters (split information and prediction parameters) to the entropy coder 104. The entropy coder 104 performs entropy coding of the coefficients and parameters to generate and output coded data Te.

The prediction parameter derivation unit 120 derives a prediction parameter from the parameters input from the coding parameter determination unit 110. The derived prediction parameter is output to the parameter coder 111.

The addition unit 106 adds, for each pixel, the pixel value for the prediction block input from the prediction image generator 101 and the prediction error input from the inverse quantization and inverse transform processing unit 105 to generate a decoded image. The addition unit 106 stores the generated decoded image in the reference picture memory 109.

The loop filter 107 applies a deblocking filter, an SAO, and an ALF to the decoded image generated by the addition unit 106. Further, the loop filter 107 need not necessarily include the above-described three types of filters, and may be configured to include only a deblocking filter, for example.

The prediction parameter memory 108 stores the prediction parameters generated by the coding parameter determination unit 110 at a predetermined position for each target picture and CU.

The reference picture memory 109 stores the decoded image generated by the loop filter 107 at a predetermined position for each target picture and CU.

The coding parameter determination unit 110 selects one set among multiple sets of coding parameters. The coding parameters include QT, BT, or TT split information described above, a prediction parameter, or a parameter to be coded which is generated in relation to the aforementioned elements. The prediction image generator 101 generates a prediction image by using these coding parameters.

The coding parameter determination unit 110 calculates an RD cost value indicating the magnitude of an amount of information and a coding error for each of the multiple sets. The RD cost value is, for example, the sum of an amount of code and the value obtained by multiplying a square error by a coefficient k. The amount of codes is an amount of information of the coded data Te obtained by performing entropy coding of a quantization error and a coding parameter. The square error is the square sum of prediction errors calculated by the subtraction unit 102. The coefficient λ is a real number greater than a preset zero. The coding parameter determination unit 110 selects a set of coding parameters of which the calculated cost value is a minimum value. The coding parameter determination unit 110 outputs the determined coding parameters to the parameter coder 111 and the prediction parameter derivation unit 120.

However, although NPL 1 is about a video coding and decoding scheme having very high coding efficiency, there is a problem in that, when image recognition is performed on a decoded image of a compressed video, image recognition accuracy is reduced due to coding distortion in a case that a transmission rate is low.

In addition, although NPL 2 discusses the method of integrating description of analysis results of a video and video coding, the method is not sufficient in terms of coding efficiency and has a problem in that a low transmission bit rate cannot be realized.

The present embodiment provides a framework capable of maintaining the accuracy in image recognition even at a low rate by coding and decoding additional supplemental information without greatly changing the framework of a video coding and decoding scheme.

### Image Recognition Supplement SEI

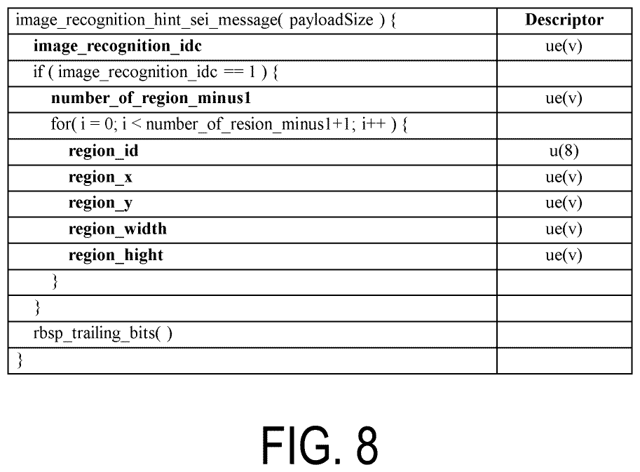

FIG. 8 is a diagram illustrating one form of syntax of supplemental information coded and decoded by the supplemental information coding apparatus 81 and the supplemental information decoding apparatus 91 of the present embodiment. In this example, SEI that is image_recognition_hint_sei_message is indicated. The SEI is intended to improve recognition accuracy and reduce the amount of processing for the image recognition apparatus to perform processing on a corresponding picture. For this reason, the SEI is an SEI message for coding and decoding at least one of the type, position, and size of a recognition target for the picture as supplemental information, and has the number of bytes of the value of payloadSize.

Syntax, syntax elements, and semantics of image_recognition_hint_sei_message in the present embodiment will be described below.

image_recognition_idc is an index value indicating the type of image recognition processing. In a case that the value of image_recognition_idc is 0, a recognition target is considered to not exist in the picture, and information of the recognition region is not described. In this example, in a case that the value of image_recognition_idc is 1, information of the recognition target is described. Further, a syntax element of the supplemental information may be added to image_recognition_idc in accordance with the type of the image recognition processing.

number of region_minus1 is a syntax element representing the number of recognition regions minus one. Information about the type, position, and size of the recognition target is described a certain number of times corresponding to the value of number_of region_minus1 plus 1.

region_id is an index value representing the type of the recognition target. The assignment of index values is determined by the image recognition apparatus 51 in accordance with the recognition target. For example, in a case that the image recognition apparatus 51 detects a person, the recognition target indicates a person in a case that the value of region_id is 0, and the recognition target indicates something other than a person in a case that the value of region_id is 1. For example, in a case that the image recognition apparatus 51 recognizes a person, a bicycle, and an automobile, the recognition target indicates a person in a case that the value of region_id is 0, the recognition target indicates a bicycle in a case that the value of region_id is 1, the recognition target indicates an automobile in a case that the value of region_id is 3, and the recognition target indicates something else in a case that the value of region_id is 4.

region_x and region_y are syntax elements indicating positions of the recognition target. region_x is an x-coordinate value (horizontal direction) of the luminance at the top left of a rectangular region. region_y is a y-coordinate value (vertical direction) of the luminance at the top left of the rectangular region. Furthermore, region_x and region_y may be relative positions in a picture. For example, they may be positions in the picture in a case that the picture size is normalized to a predetermined fixed size (for example, 512×512).

region_width and region_hight are syntax elements indicating sizes of the recognition correspondence. region_width is the number of pixels of luminance in the horizontal direction of the rectangular region. Further, the value of region_x+region_width does not exceed the number of pixels in the horizontal direction of the picture. region_hight is the number of pixels of luminance in the vertical direction of the rectangular region. Further, the value of region_y+region_height does not exceed the number of pixels in the vertical direction of the picture.

Although the present embodiment has introduced a method of setting the recognition target region to be a rectangle and representing it with coordinate values of the top left corner of the rectangle and the numbers of pixels in the horizontal direction and the vertical direction, another method may be adopted for the recognition target region. For example, the position information (region_x and region_y) of the recognition target object may be the top right, the bottom left, the bottom right, or the center of gravity, instead of the top left of the rectangular region. In addition, the sizes of the region (region_width, region_height) may be limited to those of a square other than a rectangle, and only the number of pixels on one side (region_size) may be indicated. Alternatively, the position and the size may be indicated by a unit of 4×4, a unit of 16×16, or a CTU address and the number of CTUs as a unit of coding, instead of indication in units of pixels.

rbsp_trailing_bits( ) adds bit data of 1 to 8 bits to make the number of bits of the SEI aligned in units of bytes so that the number of bytes of the SEI matches the value of payloadSize.

The image analysis apparatus 61 analyzes the input video T to detect a recognition target candidate. Here, it is only necessary to have accuracy in detecting a recognition target candidate in order to suppress the amount of processing. In addition, for example, in a case that a position of a recognition target in a picture can be assumed as in a fixed camera image, the image analysis apparatus 61 may set a detection target region in advance for a recognition candidate region.

The supplemental information creating apparatus 71 converts the information of the rectangular region of the recognition target candidate detected by the image analysis apparatus 61 into information of the position in the picture and the size of the rectangle, and sends the information to the supplemental information coding apparatus 81.

Alternatively, the output of the supplemental information creating apparatus 71 may be input to the image coding apparatus 11. In this case, the image coding apparatus 11 may control the image quality of the region portion of the recognition target candidate created by the supplemental information generation unit 71. For example, high image quality may be achieved by using a quantization parameter having a value smaller than other regions in the picture. Such an operation allows the recognition accuracy to be improved.

In addition to the decoded video Td, information on the type, position, and size of the recognition target in the picture is input to the image recognition apparatus 51 as supplemental information. As a result, it is sufficient to process only the pixels in the region of the recognition target candidate without using all information about the picture, and thus the amount of processing can be significantly reduced. In addition, since the types of recognition target candidates can be limited in advance, recognition accuracy can also be improved. Furthermore, the improvement of the image quality of the decoded image of the recognition target region causes the recognition accuracy to be improved.

According to the present embodiment, even in a case that a decoded image coded at a low rate is used, it is possible to improve the image recognition accuracy of the image recognition apparatus 51 and to reduce the amount of processing in the image recognition processing.

### Configuration of Another Video Transmission System

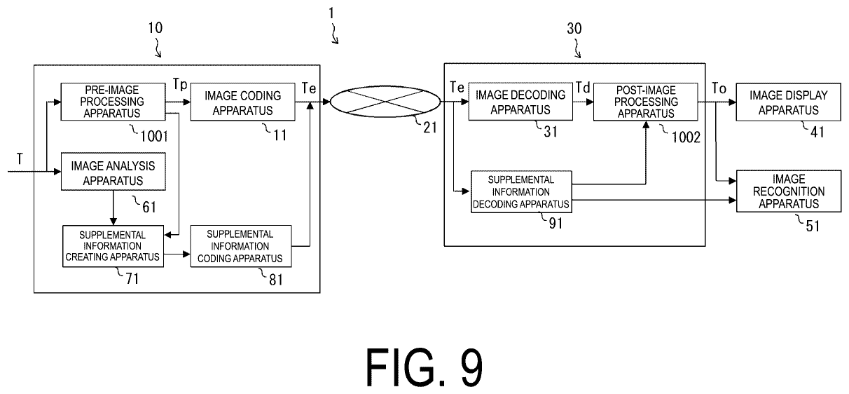

FIG. 9 is a schematic diagram illustrating a configuration of another video transmission system according to the present embodiment.

The video transmission system 1 is a system in which coded data obtained by coding an image is transmitted, the transmitted coded data is decoded and displayed, and recognition of the image is performed. The video transmission system 1 includes a video coding apparatus 10, a network 21, a video decoding apparatus 30, an image display apparatus 41, and an image recognition apparatus 51.

The video coding apparatus 10 includes an image coding apparatus (image coder) 11, an image analysis apparatus (image analyzer) 61, a supplemental information creating apparatus (supplemental information generator) 71, a supplemental information coding apparatus (supplemental information coder) 81, and a pre-image processing apparatus (pre-image processing unit) 1001.

The video decoding apparatus 30 includes an image decoding apparatus (image decoder) 31, a supplemental information decoding apparatus (supplemental information decoder) 91, and a post-image processing apparatus (post-image processing unit) 1002.

The pre-image processing apparatus 1001 performs pre-image processing on an input video T and sends a pre-processed image Tp to the image coding apparatus 11 and the supplemental information creating apparatus 71.

As an example of a specific embodiment, the information of the recognition target candidate output from the supplemental information creating apparatus 71 may be input to the pre-image processing device 1001, and low-pass filter processing may be performed on the region other than the recognition target candidate to lower the difficulty of coding and relatively improve the image quality of the region of the recognition target candidate.

The image coding apparatus 11 compresses and codes the output Tp of the pre-image processing apparatus 1001.

The image analysis apparatus 61 analyzes the input video T, analyzes information indicating which region in a picture should be used in the image recognition apparatus 51, and sends the analysis result to the supplemental information creating apparatus 71.

Based on the analysis result of the image analysis apparatus 61 and the pre-image processing Tp of the pre-image processing apparatus 1001, the supplemental information creating apparatus 71 generates, for the picture, information indicating whether to cause the image recognition apparatus 51 to operate and supplemental information indicating for which region in the picture the image recognition apparatus 51 should be caused to operate, and sends the aforementioned information to the supplemental information coding apparatus 81.

The supplemental information coding apparatus 81 codes the supplemental information created by the supplemental information creating apparatus 71 in accordance with predetermined syntax. The output of the image coding apparatus 11 and the output of the supplemental information coding apparatus 81 are sent to the network 21 as coded data Te.

The video coding apparatus 10 receives an input image T as an input, compresses and codes the image, analyzes the image, generates supplemental information to be input to the image recognition apparatus 51, codes the supplemental information, generates coded data Te, and transmits the coded data Te to the network 21.

Although the supplemental information coding apparatus 81 is not connected to the image coding apparatus 11 in FIG. 9, the supplemental information coding apparatus 81 and the image coding apparatus 11 may communicate necessary information as appropriate.

The network 21 transmits the coded supplemental information and the coded data Te to the image decoding apparatus 31. A part or all of the coded supplemental information may be included in the coded data Te as supplemental information SEI. The network 21 is the Internet, a Wide Area Network (WAN), a Local Area Network (LAN), or a combination thereof. The network 21 is not limited to a bidirectional communication network and may be a unidirectional communication network that transmits broadcast waves for terrestrial digital broadcasting, satellite broadcasting, or the like. In addition, the network 21 may be substituted with a storage medium in which the coded data Te is recorded, such as a Digital Versatile Disc (DVD) (trade name) or a Blu-ray Disc (BD) (trade name).

The video decoding apparatus 30 receives the coded data Te transmitted from the network 21 as an input, decodes the image and decodes supplemental information, and transmits the decoded image and information to the image display apparatus 41 and the image recognition apparatus 51. In addition, the supplemental information is decoded and output to the image recognition apparatus 51.

The image decoding apparatus 31 decodes each piece of the coded data Te transmitted from the network 21 to generate decoded video Td, and supplies the decoded video to a post-image processing apparatus 1002.

The supplemental information decoding apparatus 91 decodes the coded supplemental information transmitted from the network 21 to generate supplemental information and transmits the supplemental information to the image recognition apparatus 61.

Although the supplemental information decoding apparatus 91 is illustrated separately from the image decoding apparatus 31 in FIG. 9, the supplemental information decoding apparatus 91 may be included in the image decoding apparatus 31. For example, the supplemental information decoding apparatus 91 may be included in the image decoding apparatus 31 separately from each functional unit of the image decoding apparatus 31. In addition, although the supplemental information decoding apparatus 91 is not connected to the image decoding apparatus 31 in FIG. 9, the supplemental information decoding apparatus 91 and the image decoding apparatus 31 may communicate necessary information as appropriate.

The post-image processing apparatus 1002 performs post-image processing on the image decoded Td output from the image decoding apparatus 31, and outputs post-image processing To.

As an example of a specific embodiment, post-image processing may be performed by using a neural network to improve the image quality of the decoded video Td. At this time, a network parameter for improving image quality is input as supplemental information from the supplemental information decoding apparatus 91 to be used for post-image processing.

The image display apparatus 41 displays all or a part of the post-processed image To output from the post-image processing apparatus 1002. For example, the image display apparatus 41 includes a display device such as a liquid crystal display and an organic Electro-luminescence (EL) display. Examples of display types include stationary, mobile, and HMD. In addition, in a case that the image decoding apparatus 31 has a high processing capability, an image having high image quality is displayed, and in a case that the apparatus has a lower processing capability, an image which does not require a high processing capability and display capability is displayed.

The image recognition apparatus 51 uses the post-processed image To output from the post-image processing apparatus 1002 and the supplemental information decoded by the supplemental information decoding apparatus 91 to perform object detection of an image, segmentation of regions of an object, tracking of an object, motion recognition, human motion evaluation, and the like.

With such a configuration, it is possible to provide a framework capable of maintaining the accuracy in image recognition even at a low rate by coding and decoding additional supplemental information without greatly changing the framework of a video coding and decoding scheme.

### Image Recognition Post-Processing SEI

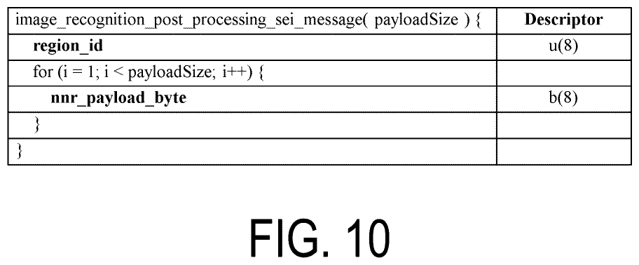

FIG. 10 is a diagram illustrating one form of syntax for performing supplemental information coding and decoding by the supplemental information coding apparatus 81 and the supplemental information decoding apparatus 91 of the present embodiment. In this example, SEI called image_recognition_post_processing_sei_message is indicated. The SEI is intended to improve accuracy in recognition in a case that the post-image processing apparatus 1002 performs post-image processing on a picture and the image recognition apparatus 51 performs image recognition processing. For this reason, the SEI is an SEI message to be coded and decoded using a network parameter for post-image processing as supplemental information and has the number of bytes of the value of payloadSize.

Syntax, syntax elements, and semantics of image_recognition_post_processing_sei_message in the present embodiment will be described below.

region_id is an index value representing the type of the recognition target the same as that of FIG. 8. The assignment of index values is determined by the image recognition apparatus 51 in accordance with the recognition target. Alternatively, it may be defined as an index value for identifying a region for each recognition target in a picture.

nnr_payload_byte is network parameter information and is a value representing, in units of bytes, data obtained by coding a network parameter used for post-image processing. The length of the coded data is (payloadSize—1) bytes.

The payloadSize represents the number of bytes of the data of SEI.

A neural network parameter is coded and decoded as a parameter representation of a neural network in a standard format such as Open Neural Network eXchange (ONNX), Neural Network Exchange Format (NNEF), or Moving Picture Experts Group Newral Network Coding (MPEG NNC), or a library-dependent format such as tensorflow or pytorch.

In addition, the supplemental information creating apparatus 71, the supplemental information coding apparatus 81, and the supplemental information decoding apparatus 91 may store a general-purpose network parameter in common. The supplemental information creating apparatus 71 may create a network parameter for partially updating the general-purpose network stored in common as supplemental information, the supplemental information coding apparatus 81 may perform coding, and the supplemental information decoding apparatus 91 may perform decoding. Such a configuration allows the amount of codes of the supplemental information to be reduced, and allows the supplemental information in accordance with the input image T to be created, coded, and decoded.

In addition, as a transmission format of the network parameter, a parameter (identifier) indicating a format may be transmitted in order to support multiple formats. In addition, actual supplemental information following the identifier may be transmitted in a byte string.

The supplemental information of the network parameter decoded by the supplemental information decoding apparatus 91 is input to the post-image processing apparatus 1002.

By using the decoded supplemental information, the post-image processing apparatus 1002 performs post-image processing using the neural network, and reconstructs the decoded video Td.

In addition, the post-image processing may be performed only on a recognition target candidate region by using information of region_id of the image recognition supplement SEI simultaneously with the supplemental information of the image recognition supplement SEI illustrated in FIG. 8.

This allows the image quality of the decoded video Td to be improved on the decoded image side, and allows the accuracy in recognition of the image recognition apparatus to be improved.

Further, coding and decoding of network parameters are not limited to becoming SEI, and may be performed by using syntax with an SPS, a PPS, an APS, a slice header, or the like.

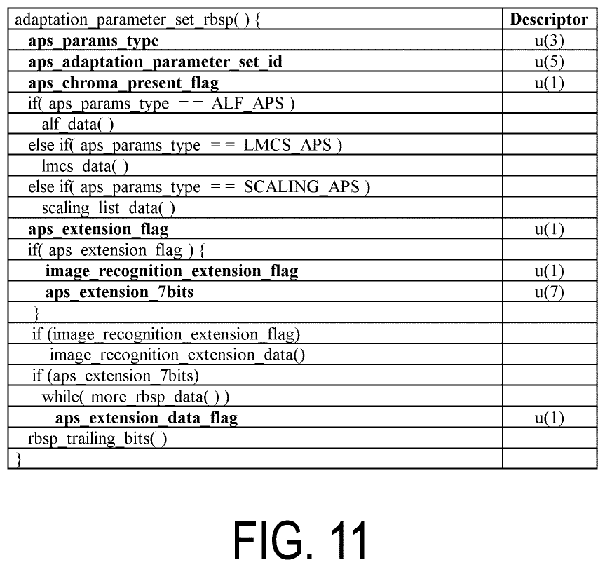

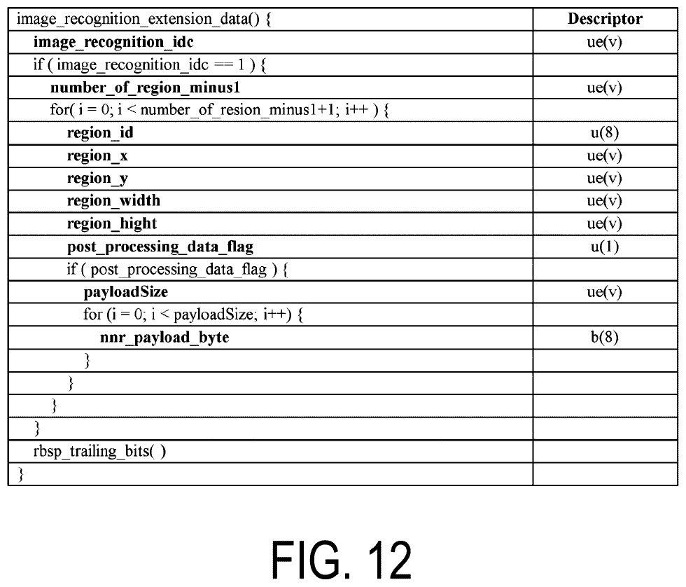

The supplemental coding apparatus 81 codes the supplemental information, based on the syntax tables of FIG. 8, FIG. 10, or FIG. 11 and FIG. 12. In a case of the syntax table in FIG. 8 or FIG. 10, the supplemental information is coded as supplemental enhancement information SEI, multiplexed into coded data Te output by the image coding apparatus 11, and output to the network 21. In the case of the syntax tables in FIGS. 11 and 12, the supplemental information is coded as APS and output as a part of the coded data Te output from the image coding apparatus 11.

The supplemental information decoding apparatus 91 decodes the supplemental information from the coded data Te based on the syntax tables of FIG. 8, FIG. 10 or FIGS. 11 and 12, and transmits the decoded results to the post-image processing apparatus 1002 and the image recognition apparatus 51. In the case of the syntax tables of FIGS. 8 and 10, the supplemental information decoding apparatus 91 decodes the supplemental information coded as the supplemental enhancement information SEI. In the case of the syntax tables of FIGS. 11 and 12, the supplemental information decoding apparatus 91 decodes the supplemental information coded as the APS.

The post-image processing apparatus 1002 performs post-image processing on the decoded video Td by using the decoded video Td and the supplemental information, and generates post-image processing To.

### Image Recognition Supplemental Information APS

FIG. 11 is a diagram illustrating an example of a syntax table in which an Adaptation Parameter Set (APS) for image recognition enhancement has been enhanced in the present embodiment. The syntax table may include the following syntax elements as illustrated in FIG. 12.

aps_extension_flag is a flag indicating that there is enhanced data of the APS. In a case that aps_extension_flag is 1, image_recognition_extension_flag is coded. In a case that aps_extension_flag is 0, enhanced data of the APS does not exist, and thus image_recognition_extension_flag is inferred to be 0 without being coded.

image_recognition_extension_flag is a flag indicating the presence of image recognition enhancement data. It is also a flag indicating whether to code and decode the syntax of image_recognition_extension_datao. In a case that image_recognition_extension_flag is 1, the syntax of image_recognition_extension_datao is coded and decoded. image_recognition_extension_datao is a syntax including image recognition supplemental information.

FIG. 12 is an example of the syntax of image_recognition_extension_datao which is one piece of the enhancement information of the APS. image_recognition_extension_datao includes network parameter information used for image recognition enhancement.

The enhancement data of the APS is intended to improve accuracy in recognition and reduce the amount of processing in a case that the image recognition apparatus performs processing on a corresponding picture. For this purpose, the type, position, and size of a recognition target with respect to the picture are described as supplemental information.

As an example in the present embodiment, the syntax, syntax elements, and semantics of image_recognition_extension_datao will be described below.

image_recognition_idc is an index value indicating the type of image recognition processing. In a case that the value of image_recognition_idc is 0, it is assumed that the recognition target does not exist in the picture, and the information of the recognition region and the information of the network parameter for post-image processing are not described. In this example, in a case that the value of image_recognition_idc is 1, information of the recognition target is described. Further, a syntax element of the supplemental information may be added to image_recognition_idc in accordance with the type of the image recognition processing.

In a case that the value of image_recognition_idc is 1, information of the recognition region is described, and thus the same syntax as that of the image recognition supplement SEI of FIG. 8 is described.

number of region_minus1 is a syntax element representing the number of recognition regions minus one. Information about the type, position, and size of the recognition target is described a certain number of times corresponding to the value of number_of region_minus1 plus 1.

region_id is an index value representing the type of the recognition target. The assignment of index values is determined in accordance with the recognition target of the image recognition apparatus. For example, in a case that the image recognition apparatus detects a person, the recognition target indicates a person in a case that the value of region_id is 0, and the recognition target indicates something other than a person in a case that the value of region_id is 1. For example, in a case that the image recognition apparatus recognizes a person, a bicycle, and an automobile, the recognition target indicates a person in a case that the value of region_id is 0, the recognition target indicates a bicycle in a case that the value of region_id is 1, the recognition target indicates an automobile in a case that the value of region_id is 2, and the recognition target indicates something else in a case that the value of region_id is 3.

region_x and region_y are syntax elements indicating positions of the recognition target. region_x is an x-coordinate value (horizontal direction) of the luminance at the top left of a rectangular region. region_y is a y-coordinate value (vertical direction) of the luminance at the top left of the rectangular region.

region_width and region_hight are syntax elements indicating sizes of recognition correspondence. region_width is the number of pixels of the rectangular region in luminance in the horizontal direction. Further, the value of region_x+region_width does not exceed the number of pixels of the picture in the horizontal direction. region_hight is the number of pixels of the rectangular region in luminance in the vertical direction. Further, the value of region_y+region_height does not exceed the number of pixels of the picture in the vertical direction.

Although the present embodiment has introduced a method of setting the recognition target region to be a rectangle and representing it with coordinate values of the top left corner of the rectangle and the numbers of pixels in the horizontal direction and the vertical direction, another method may be adopted for the recognition target region. For example, the position information of the rectangle may be the top right, the bottom left, the bottom right, or the center of gravity, instead of the top left of the rectangular region. The recognition target region may be limited to a square, instead of a rectangle, and only the number of pixels on one side may be indicated. Alternatively, the recognition target region may be indicated by a CTU address and the number of CTUs as a unit of coding instead of a rectangle or a square.

post_processing_data_flag is a flag indicating whether to perform post-image processing on the decoded video Td by using the post-image processing apparatus 1002. In a case that the flag indicates TRUE, network parameter information used for post-image processing is described.

payloadSize is a number representing the number of bytes of the network parameter.

nnr_payload_byte is network parameter information and is a value representing, in units of bytes, data obtained by coding a network parameter used for post-image processing. The length of the coded data is payloadSize bytes.

A neural network parameter is coded and decoded as a parameter representation of a neural network in a standard format such as Open Neural Network eXchange (ONNX), Neural Network Exchange Format (NNEF), or Moving Picture Experts Group Newral Network Coding (MPEG NNC), or a library-dependent format such as tensorflow or pytorch.

rbsp_trailing_bits( ) adds data of 1 to 8 bits so that the number of bits of the APS is aligned in units of bytes.

In addition, the supplemental information creating apparatus 71, the supplemental information coding apparatus 81, and the supplemental information decoding apparatus 91 may store a general-purpose network parameter in common. The supplemental information creating apparatus 71 may create a network parameter for partially updating the general-purpose network stored in common as supplemental information, the supplemental information coding apparatus 81 may perform coding, and the supplemental information decoding apparatus 91 may perform decoding. Such a configuration allows the amount of codes of the supplemental information to be reduced, and allows the supplemental information in accordance with the input image T to be created, coded, and decoded.

In addition, as a transmission format of the network parameter, a parameter (identifier) indicating a format may be transmitted in order to support multiple formats. In addition, actual supplemental information following the identifier may be transmitted in a byte string.

The supplemental information of the network parameter decoded by the supplemental information decoding apparatus 91 is input to the post-image processing apparatus 1002.

The network parameter is used by the post-image processing apparatus 1002 to perform post-image processing on a recognition target candidate region by using a neural network. This allows the image quality of the decoded video Td of the recognition target candidate region to be improved and allows the accuracy in recognition by the image recognition apparatus to be improved.

Further, although the syntax with APSs has been described as an example of the present embodiment, it is not limited to APSs, and syntax with an SPS, a PPS, a slice header, or the like may be used.

With such a configuration, it is possible to solve the problem of maintaining the accuracy in image recognition even at a low rate by coding and decoding additional supplemental information without greatly changing the framework of a video coding and decoding scheme.

Further, a computer may be used to implement some of the image coding apparatus 11 and the image decoding apparatus 31 in the above-described embodiments, for example, the entropy decoder 301, the parameter decoder 302, the loop filter 305, the prediction image generator 308, the inverse quantization and inverse transform processing unit 311, the addition unit 312, the prediction parameter derivation unit 320, the prediction image generator 101, the subtraction unit 102, the transform and quantization unit 103, the entropy coder 104, the inverse quantization and inverse transform processing unit 105, the loop filter 107, the coding parameter determination unit 110, the parameter coder 111, and the prediction parameter derivation unit 120. In that case, this configuration may be realized by recording a program for realizing such control functions on a computer-readable recording medium and causing a computer system to read and perform the program recorded on the recording medium. Note that the “computer system” mentioned here refers to a computer system built into either the image coding apparatus 11 or the image decoding apparatus 31 and is assumed to include an OS and hardware components such as a peripheral apparatus. In addition, the “computer-readable recording medium” refers to a portable medium such as a flexible disk, a magneto-optical disk, a ROM, and a CD-ROM, and a storage apparatus such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

In addition, a part or all of the image coding apparatus 11 and the image decoding apparatus 31 in the embodiments described above may be implemented as an integrated circuit such as a Large Scale Integration (LSI). Function blocks of the image coding apparatus 11 and the image decoding apparatus 31 may be individually realized as processors, or some or all of the function blocks may be integrated into processors. In addition, the circuit integration technique is not limited to LSI, and implementation as a dedicated circuit or a multi-purpose processor may be adopted. In addition, in a case that a circuit integration technology that replaces LSI appears as the semiconductor technologies advance, an integrated circuit based on that technology may be used.

Although embodiments of the present invention have been described above in detail with reference to the drawings, the specific configurations thereof are not limited to those described above and various design changes or the like can be made without departing from the spirit of the invention.

### Application Example

The video coding apparatus 10 and the video decoding apparatus 30 described above can be installed and used in various apparatuses performing transmission, reception, recording, and playback of videos. Further, a video may be a natural video imaged by a camera or the like, or may be an artificial video (including CG and GUI) generated by a computer or the like.

An embodiment of the present invention is not limited to those described above and various changes can be made within the scope indicated by the claims. That is, embodiments obtained by combining technical means appropriately modified within the scope indicated by the claims are also included in the technical scope of the present invention.

### INDUSTRIAL APPLICABILITY

The embodiments of the present invention can be preferably applied to a video decoding apparatus for decoding coded data in which image data is coded, and a video coding apparatus for generating coded data in which image data is coded. In addition, the embodiments of the present invention can be preferably applied to a data structure of coded data generated by the video coding apparatus and referred to by the video decoding apparatus.

1. A video decoding apparatus for decoding an image from coded data, the video decoding apparatus comprising:
a supplemental information decoder that decodes supplemental information indicating at least one of a position, a size, or a type of a recognition target of a decoded image.

2. The video decoding apparatus according to claim 1, wherein
the supplemental information decoder decodes a network parameter used for image reconstruction of a recognition target region as the supplemental information.

3. A post-image processing apparatus comprising:
a post-image processing circuit that perform a post-image processing by using a network parameter, which is information decoded by using supplemental information indicating at least one of a position, a size, or a type of a recognition target of an image.

4. The post-image processing apparatus according to claim 3, wherein
the post-image processing circuit performs only on a candidate region indicated by the supplemental information.

5. A video coding apparatus for coding an input image, the video coding apparatus comprising:
supplemental information coder that codes supplemental information indicating at least one of a position, a size, or a type of a recognition target of the input image.

6. The video coding apparatus according to claim 5, wherein
the supplemental information coder codes a network parameter used for image reconstruction of a recognition target region as the supplemental information.

7-8. (canceled)
